(19) United States
(12) Patent Application Publication
(10) Pub. No.: US 2016/0117786 A1
(43) Pub. Date: Apr. 28, 2016

(54) RESIDENTIAL PIPELINE PLATFORM METHODS, APPARATUSES, AND MEDIA

(71) Applicant: Nancy Packes, Inc., New York, NY (US)

(72) Inventors: Nancy Packes, New York, NY (US); Daniel Banker, West Caldwell, NJ (US); Emilien Benoit Manvieu, Arconnay (FR); Jean Francois Chatelain, Longueuil (CA)

(21) Appl. No.: 14/921,966

(22) Filed: Oct. 23, 2015

Related U.S. Application Data
(60) Provisional application No. 62/067,590, filed on Oct. 23, 2014.

(51) Int. Cl. G06Q 50/16; H04L 12/58

(52) U.S. Cl. CPC G06Q 50/165; H04L 51/36

(57) ABSTRACT

Pipeline information regarding real estate construction jobs may be obtained from a data feed. A new real estate development associated with a specified job type, and a building identification number for the new real estate development may be identified from the pipeline information. Additional information regarding the new real estate development may be obtained by sending a query that includes the building identification number to a data source. A geographic area and a unit type associated with the new real estate development may be determined based on information regarding the new real estate development. User data may be analyzed to identify a user interested in pipeline information associated with the geographic area and the unit type. An electronic message regarding the new real estate development may be sent to the user.

This disclosure describes RESIDENTIAL PIPELINE PLATFORM METHODS, APPARATUSES, AND MEDIA (hereinafter “RPP”). A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### CROSS-REFERENCE TO RELATED APPLICATION(S)

Applicant hereby claims priority under 35 U.S.C. §119 to U.S. provisional patent application No. 62/067,590, filed Oct. 23, 2014, entitled “RESIDENTIAL PIPELINE PLATFORM METHODS, APPARATUSES AND MEDIA,” docket no. 2400-106PV1.

The entire contents of the aforementioned application are herein expressly incorporated by reference in their entirety.

### FIELD

The present disclosure is directed generally to modeling platforms.

### BACKGROUND

In the real estate industry, the term “pipeline” is used to describe the supply of construction that is planned but has not yet come to market. In particular, in the residential marketplace, the term pipeline includes multifamily, rental, condominium and hotel units, that is, units that can be occupied for residential purposes.

### BRIEF DESCRIPTION OF THE FIGURES

The accompanying figures, in which like reference characters may refer to like parts throughout, illustrate various exemplary embodiments in accordance with the present disclosure.

FIG. 1 shows a block diagram illustrating a system with an exemplary RPP coordinator in accordance with some embodiments of the RPP.

FIGS. 2-5 show logic flow diagrams illustrating various processes for managing an RPP pipeline database in accordance with some embodiments of the RPP.

FIGS. 6-12J show screen shot diagrams illustrating various exemplary user interfaces in accordance with some embodiments of the RPP.

### DETAILED DESCRIPTION

### Summary

The RPP may be utilized to identify, extract, and/or match relevant information from various data sources (e.g., government databases, journalistic and other narrative descriptions, etc.) of data regarding real estate development to create a real estate development model.

In one embodiment, the RPP may project whether a planned development will be a rental, condominium, or hotel. In one implementation, this may be done by examining the unit types of similar developments that have already come to market in order to project the probable use of the planned development.

In another embodiment, the RPP may project the time when a planned development is likely to come to market. In one implementation, this may be done by looking at similarly sized developments to estimate construction time for the planned development.

Utilizing the RPP may allow professionals in the residential industry, including developers, investors, lenders, and contractors, to understand the volume, type, and timing of planned real estate developments in order to assess the risk associated with any future developments. The RPP may also be utilized by government officials in order to understand areas where changes in zoning laws and/or other urban planning issues might be informed by market driven trends in the pipeline of new developments.

In various implementations, the RPP may be accessed by a user via a website, a mobile app, an application, and/or the like. The user may utilize the RPP to analyze real estate development data, to generate reports, to receive email updates (e.g., regarding changes in a geographic area of interest to the user), to collaborate with other users in the user's network, and/or the like.

For example, in some embodiments, a processor-implemented electronic pipeline update message generating method may include obtaining, via a network, from a data feed, pipeline information regarding real estate construction jobs, identifying, via a processor, a new real estate development and a building identification number for the new real estate development from the pipeline information, wherein the new real estate development is associated with a specified job type, obtaining, via the network, additional information regarding the new real estate development by sending a query to a data source, wherein the query includes the building identification number, determining, via the processor, based on information regarding the new real estate development, a geographic area and a unit type associated with the new real estate development, analyzing, via the processor, user data to identify a user interested in pipeline information associated with the geographic area and the unit type, and sending, via the network, an electronic message regarding the new real estate development to the user.

This Summary is provided merely to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### Detailed Description of the RPP Coordinator

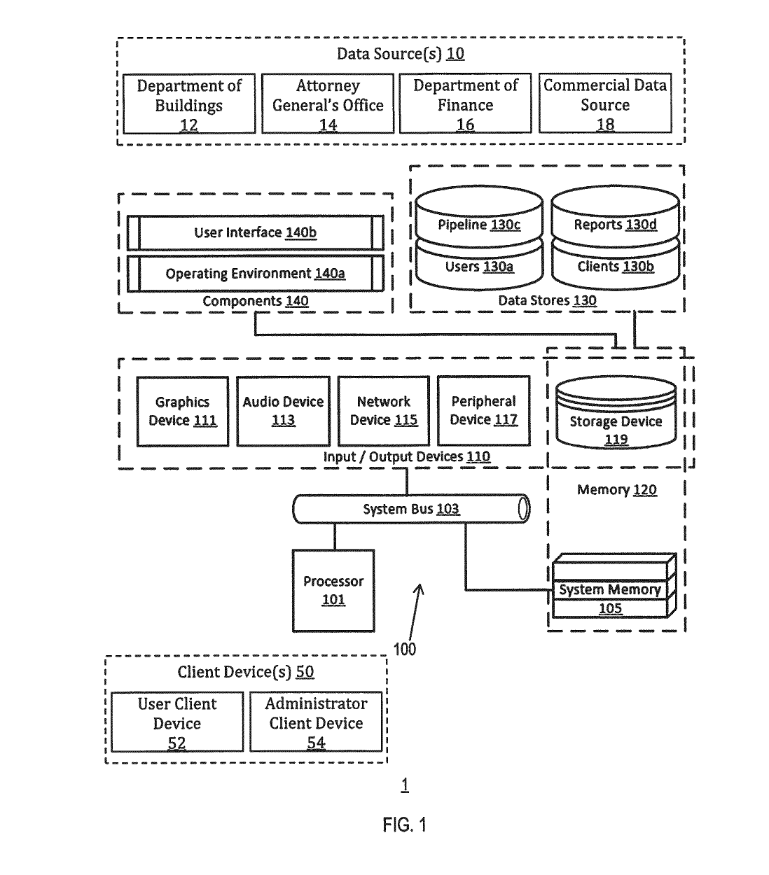

FIG. 1 shows a block diagram illustrating a system 1 with an exemplary RPP coordinator 100, at least one remote data source 10 that may be communicatively coupled to the RPP coordinator 100, and/or at least one remote client device 50 that may be communicatively coupled to the RPP coordinator 100, in at least one embodiment of the RPP. The RPP coordinator facilitates the operation of the RPP via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the RPP coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the RPP coordinator may include a standalone computer system, a distributed computer system, a node in a computer network (i.e., a network of computer systems organized in a topology), a network of RPP coordinators, and/or the like. It is to be understood that the RPP coordinator and/or the various RPP coordinator elements (e.g., processor, system bus, memory, input/output devices) may be organized in any number of ways (i.e., using any number and configuration of computer systems, computer networks, nodes, RPP coordinator elements, and/or the like) to facilitate RPP operation. Furthermore, it is to be understood that the various RPP coordinator computer systems, RPP coordinator computer networks, RPP coordinator nodes, RPP coordinator elements, and/or the like may communicate among each other in any number of ways to facilitate RPP operation. As used in this disclosure, the term “user” may refer generally to people and/or computer systems that interact with the RPP; the term “server” may refer generally to a computer system, a program, and/or a combination thereof that may handle requests and/or may respond to requests from clients via a computer network; the term “client” may refer generally to a computer system, a program, a user, and/or a combination thereof that may generate requests and/or may handle responses from servers via a computer network; the term “node” may refer generally to a server, to a client, and/or to an intermediary computer system, program, and/or a combination thereof that may facilitate transmission of and/or handling of requests and/or responses.

The RPP coordinator may include a processor 101 that may execute program instructions (e.g., RPP program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may include one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be coupled to system memory 105 via a system bus 103. The system bus may intercouple or interconnect these and/or other elements of the RPP coordinator via electrical, electronic, optical, wireless, and/or the like communication links (e.g., the system bus may be integrated into a motherboard that may intercouple or interconnect RPP coordinator elements and may provide power from a power supply). In various embodiments, the system bus may include one or more control buses, address buses, data buses, memory buses, peripheral buses, and/or the like. In various implementations, the system bus may be a parallel bus, a serial bus, a daisy chain design, a hub design, and/or the like. For example, the system bus may include a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may include registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., RPP program instructions) executed by the processor. The system memory may facilitate accessing, storing, retrieving, modifying, deleting, and/or the like data (e.g., RPP data) by the processor.

In various embodiments, input/output devices 110 may be coupled to the processor and/or to the system memory, and/or to one another via the system bus.

In some embodiments, the input/output devices may include one or more graphics devices 111. The processor may make use of the one or more graphic devices in accordance with program instructions (e.g., RPP program instructions) executed by the processor. In one implementation, a graphics device may be a video card that may obtain (e.g., via a connected video camera), process (e.g., render a frame), output (e.g., via a coupled monitor, television, and/or the like), and/or the like graphical (e.g., multimedia, video, image, text) data (e.g., RPP data). A video card may be coupled to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 113. The processor may make use of the one or more audio devices in accordance with program instructions (e.g., RPP program instructions) executed by the processor. In one implementation, an audio device may be a sound card that may obtain (e.g., via a coupled microphone), process, output (e.g., via coupled speakers), and/or the like audio data (e.g., RPP data). A sound card may be coupled to the system bus via an interface such as PCI, PCI Express, USB, PC Card, ExpressCard, and/or the like. A sound card may be coupled via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC'97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 115. The processor may make use of the one or more network devices in accordance with program instructions (e.g., RPP program instructions) executed by the processor. In one implementation, a network device may be a network card that may obtain (e.g., via a Category 5 Ethernet cable), process, output (e.g., via a wireless antenna), and/or the like network data (e.g., RPP data) from one or more of the at least one data source 10 of system 1 and/or communicate data with one or more of the at least one client device 50 of system 1. Any suitable network device 115 may be operative to communicate any suitable data to and/or from any suitable data source 10 and/or to and/or from any suitable client device 50 using any suitable communication protocol over any suitable communication medium (e.g., a wired medium or a wireless medium or a combination thereof (not shown)). A network card may be coupled to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to couple to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 117. The processor may make use of the one or more peripheral devices in accordance with program instructions (e.g., RPP program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be coupled to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the RPP coordinator with a variety of input, output and processing capabilities.

In some embodiments, the input/output devices may include one or more storage devices 119. The processor may access, read from, write to, store in, erase, modify, and/or the like a storage device in accordance with program instructions (e.g., RPP program instructions) executed by the processor. A storage device may facilitate accessing, storing, retrieving, modifying, deleting, and/or the like data (e.g., RPP data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be coupled to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 105 and the one or more storage devices 119 may be referred to as memory 120 (i.e., physical memory).

RPP memory 120 may contain processor-operable (e.g., accessible) RPP data stores 130. Data stores 130 may include data that may be used (e.g., by the RPP) via the RPP coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, RPP coordinator elements, and/or the like) to facilitate RPP operation. For example, RPP data stores may include data stores 130a-130d that may be implemented as one or more databases. A users data store 130a may be a collection of database tables that include fields such as UserID, UserName, UserPreferences, UserReports, and/or the like. A clients data store 130b may be a collection of database tables that include fields such as ClientID, ClientName, ClientDeviceType, ClientScreenResolution, and/or the like. A pipeline data store 130c may be a collection of database tables that include fields such as PropertyID, PropertyStatus, PropertyDetails, PropertyOnlineYear, PropertyAcceptedDate, PropertyTCODate, PropertyCODate, PropertyName, PropertyAddress, PropertyCrossStreet, PropertyBorough, PropertyArea, PropertyNeighborhood, PropertyZipCode, PropertyBin, PropertyBlock, PropertyType, PropertyOwner, PropertyDeveloper, PropertyNumFloors, PropertyNumUnits, PropertyNumAffordableUnits, PropertyMRRU, PropertyMRCU, and/or the like. A reports data store 130d may be a collection of database tables that include fields such as ReportID, ReportFilterSettings, ReportOutputSettings, and/or the like. The RPP coordinator may use data stores 130 to keep track of inputs, parameters, settings, variables, records, outputs, and/or the like.

RPP memory 120 may contain processor-operable (e.g., executable) RPP components 140. Components 140 may include program components (including program instructions and any associated data stores) that may be executed (e.g., by the RPP) via the RPP coordinator (i.e., via the processor) to transform RPP inputs into RPP outputs. It is to be understood that the various components and their subcomponents, capabilities, applications, and/or the like may be organized in any number of ways (i.e., using any number and configuration of components, subcomponents, capabilities, applications, RPP coordinator elements, and/or the like) to facilitate RPP operation. Furthermore, it is to be understood that the various components and their subcomponents, capabilities, applications, and/or the like may communicate among each other in any number of ways to facilitate RPP operation. For example, the various components and their subcomponents, capabilities, applications, and/or the like may be combined, integrated, consolidated, split up, distributed, and/or the like in any number of ways to facilitate RPP operation. In another example, a single or multiple instances of the various components and their subcomponents, capabilities, applications, and/or the like may be instantiated on each of a single RPP coordinator node, across multiple RPP coordinator nodes, and/or the like.

One, some, any, or all of the processes described herein may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include, but are not limited to, a read only memory, a random access memory, a flash memory, a CD ROM, a DVD, a magnetic tape, a removable memory card, and a data storage device. In other embodiments, the computer-readable medium may be a transitory computer-readable medium. In such embodiments, the transitory computer-readable medium can be distributed over network coupled computer systems so that the computer-readable code may be stored and executed in a distributed fashion. For example, such a transitory computer-readable medium may be communicated from one electronic device to another electronic device using any suitable communications protocol (e.g., the computer-readable medium or any suitable portion thereof may be communicated amongst any suitable servers and/or devices to RPP coordinator 100). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal. It is to be understood that any, each, or at least one module or component or subsystem or server of the disclosure may be provided as a software construct, firmware construct, one or more hardware components, or a combination thereof. For example, any, each, or at least one module or component or subsystem or server of the disclosure may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and servers and components and subsystems of the disclosure are merely illustrative, and that the number, configuration, functionality, and interconnection of existing modules, servers, components, and/or subsystems of the disclosure may be modified or omitted, additional modules, servers, components, and/or subsystems may be added, and the interconnection of certain modules, servers, components, and/or subsystems may be altered.

In various embodiments, program components may be developed using one or more programming languages, techniques, tools, and/or the like such as an assembly language, Ada, BASIC, C, C++, C#, F#, COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), WebSocket Protocol, Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like (e.g., a functional programming language with advantageous programming capabilities for fast processing algorithms, such as may be used for any suitable process of the disclosure).

In some embodiments, components 140 may include an operating environment component 140a. The operating environment component may facilitate operation of the RPP via various subcomponents.

In some implementations, the operating environment component may include an operating system subcomponent. The operating system subcomponent may provide an abstraction layer that may facilitate the use of, communication among, common services for, interaction with, security of, and/or the like of various RPP coordinator elements, components, data stores, and/or the like.

In some embodiments, the operating system subcomponent may facilitate execution of program instructions (e.g., RPP program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the RPP. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the RPP coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the RPP coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the RPP by providing user interface elements that may be used by the RPP to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may include a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may include an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate RPP capabilities such as storage, analysis, retrieval, access, modification, deletion, aggregation, generation, and/or the like of data (e.g., the use of data stores 130). The database subcomponent may make use of database languages (e.g., Structured Query Language (SQL), XQuery), stored procedures, triggers, APIs, and/or the like to provide these capabilities. In various embodiments the database subcomponent may include a cloud database, a data warehouse, a distributed database, an embedded database, a parallel database, a real-time database, and/or the like. For example, the database subcomponent may include a database such as Microsoft SQL Server, Microsoft Access, MySQL, IBM DB2, Oracle Database, Apache Cassandra database, and/or the like.

In some implementations, the operating environment component may include an information handling subcomponent. The information handling subcomponent may provide the RPP with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, RPP components, nodes in a computer network, web browsers, and/or the like. For example, the information handling subcomponent may include a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 130) via the database subcomponent.

In some embodiments, the information handling subcomponent may facilitate presentation of information obtained from users, RPP components, nodes in a computer network, web servers, and/or the like. For example, the information handling subcomponent may include a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate RPP message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate RPP message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may include Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates RPP security. In some embodiments, the security subcomponent may restrict access to the RPP, to one or more services provided by the RPP, to data associated with the RPP (e.g., stored in data stores 130), to communication messages associated with the RPP, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the RPP may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may include a cryptographic system such as Pretty Good Privacy (PGP).

In some implementations, the operating environment component may include a virtualization subcomponent that facilitates RPP virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may include VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 140 may include a user interface component 140b. The user interface component may facilitate user interaction with the RPP by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like. An administrator or any other applicable user of RPP coordinator 100 may interact with any suitable component(s) of components 140 and/or with any suitable I/O devices of devices 110 for interfacing with RPP coordinator 100 in any suitable manner.

In the real estate industry, the term “pipeline” may be used to describe the supply of construction that may be planned but has not yet come to market. In particular, in the residential marketplace, the term pipeline may include multifamily, rental, condominium, hotel units, and/or any other suitable units that may be occupied for residential purposes. Construction may also be related to commercial units or any other suitable units of interest.

Information about the pipeline of units may be provided to RPP coordinator 100 by any suitable data source 10. For example, such information may be found in or otherwise provided by journalistic articles and other news publications from journalistic or any suitable commercial data source 18 (e.g., blogs, corporate websites, etc.) and/or may be provided by any suitable official sources as the construction process may be documented through agencies of government, such as the Department of Buildings 12, the Attorney General's Office 14, and the Department of Finance 16 (e.g., of the City of New York), and/or from any other suitable agencies or data sources. References to the pipeline of residential development may be scattered throughout the agencies of government.

In one embodiment, RPP coordinator 100 may identify and extract relevant information from any suitable data sources of data source(s) 10 of system 1 (e.g., government data sources 12, 14, 16, etc.) and may then match that data to journalistic and other narrative descriptions of new development from any suitable data sources of data source(s) 10 of system 1 (e.g., commercial data source 18, etc.). This process may be exceedingly complicated because of the frequent lack of a specific address for a particular development in the pipeline and, even when an address is given, correlating that address to the official address of the location in public databases may be difficult.

In another embodiment, RPP coordinator 100 may project whether a particular planned development will be a rental, condominium, or hotel. This may be done by configuring RPP coordinator 100 to examine the unit types of similar developments that have already come to market in order to project the probable use of a particular planned development.

In yet another embodiment, RPP coordinator 100 may project the time when particular planned development will probably come to market. This may be done by configuring RPP coordinator 100 to process information related to similarly sized developments to estimate construction time.

Utilizing RPP coordinator 100 may allow any suitable users (e.g., any user of a user client device 52 of client device(s) 50), such as devices controlled by professionals in the residential industry, including developers, investors, lenders, and contractors, to understand the volume, type, and timing of planned developments in order to assess the risk associated with any future development, and/or devices controlled by government officials to help understand areas where changes in the zoning laws, and other urban planning issues, might be informed by trends evinced by market forces in the pipeline of new development. For example, any device of client device 50 may be any suitable device (e.g., a desktop, a laptop, a tablet, a smartphone, etc.) that may be operative to utilize a website to input instructions for and/or to receive data from RPP coordinator 100 and/or that may be operative to utilize a mobile app to input instructions for and/or to receive data from RPP coordinator 100 and/or that may be operative to utilize an external application (e.g., that may utilize an application program interface (API) to communicate with RPP coordinator 100) to input instructions for and/or to receive data from RPP coordinator 100. For example, a user's instructions may include selections, filters, input data (e.g., notes, etc.), and/or the like.

### Detailed Description of Processes for Managing Pipeline Data

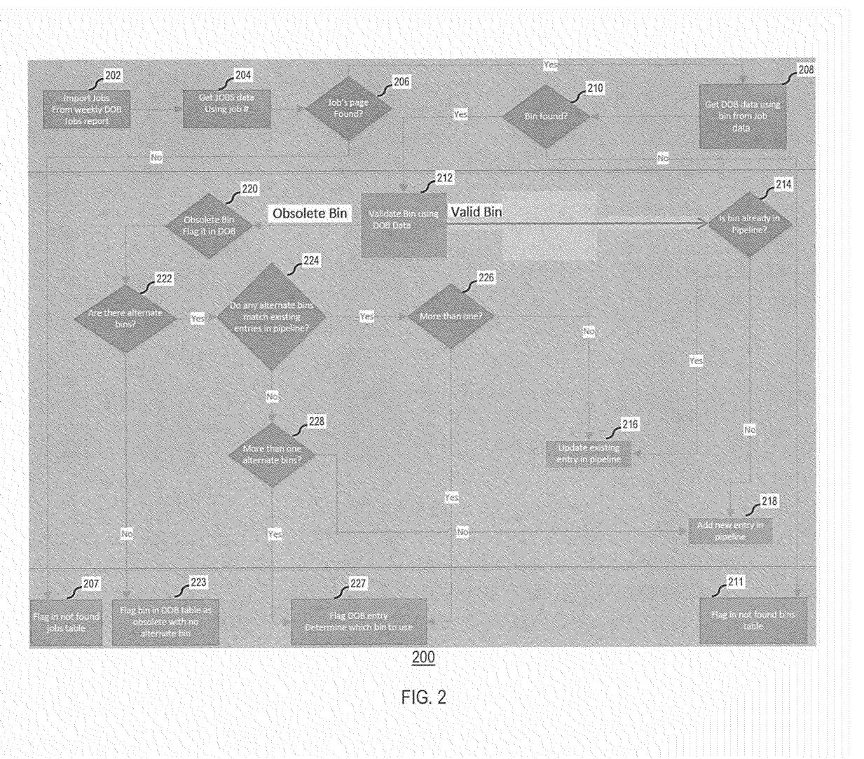

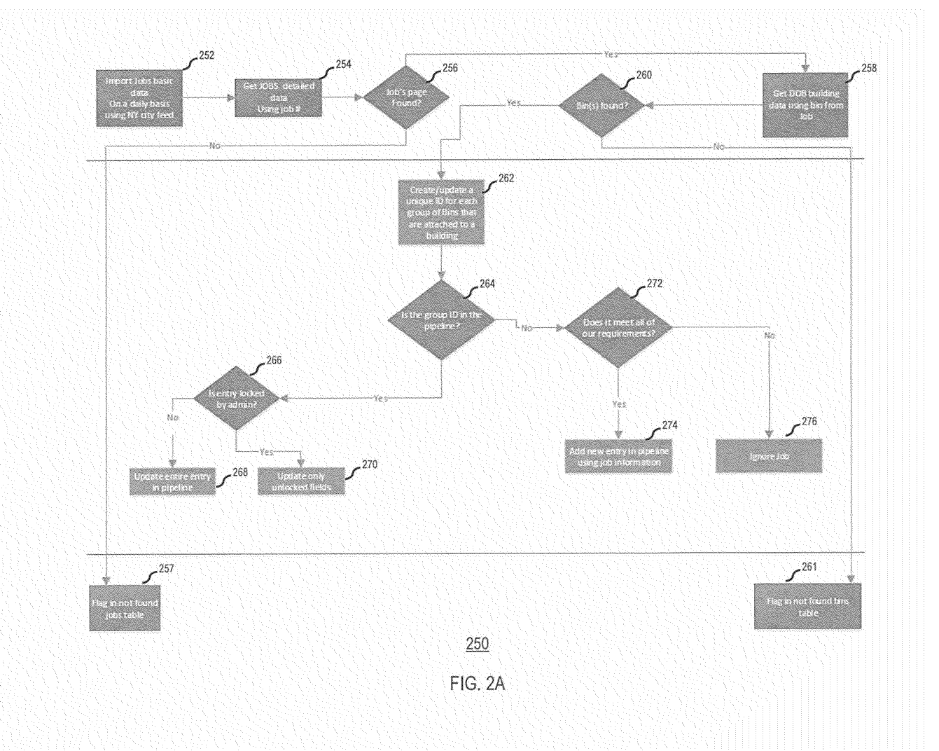

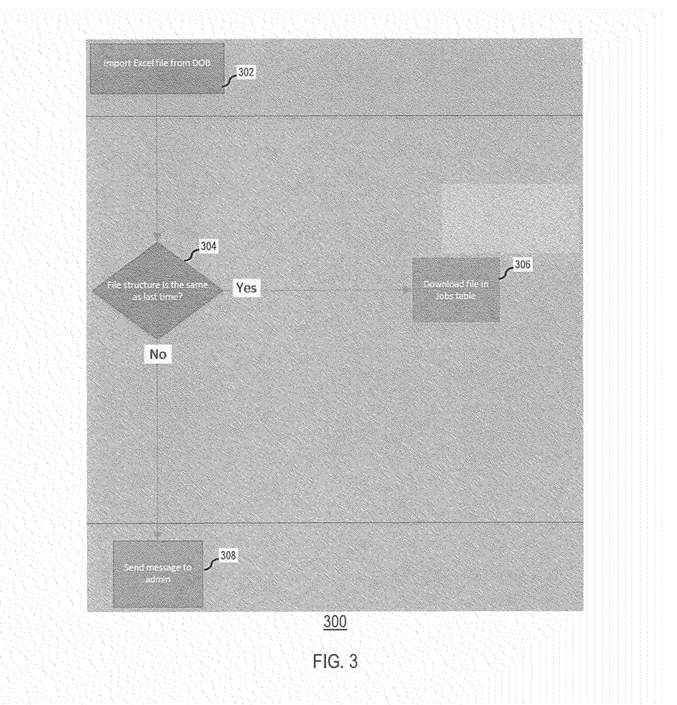

FIG. 2 is a flowchart of an illustrative process 200 for managing pipeline data (e.g., as may be carried out by the RPP (e.g., by RPP coordinator 100 of system 1)). At step 202, process 200 may include importing pipeline data from a data source. For example, step 202 may include RPP coordinator 100 importing (e.g., downloading, such as via push techniques or via pull techniques) pipeline job data from any suitable data source 10, such as from the Department of Buildings (DOB) data source 12. Such pipeline job data may be any suitable data, such as a jobs report from the DOJ (e.g., a Jobs Report as may be provided as an update in the NYC OpenData database). RPP coordinator 100 may be communicatively coupled to the appropriate data source for downloading such pipeline data at any suitable time (e.g., daily, weekly, when any new data is available, etc.). Continuing with a particular example where a jobs report may be imported at step 202, such a jobs report may include one or more job numbers that may be associated with one or more developments in the pipeline. For the import of step 202, various thresholds or characteristics may be used to limit the types of jobs that are imported. For example, only new building (NB) jobs with a specified threshold number of proposed dwelling units (e.g., at least 4) may be considered for the import into the RPP at step 202. Additionally or alternatively, alteration 1 (A1) jobs with a specified threshold number of proposed dwelling units (e.g., at least 4) and a specified threshold number of existing dwelling units (e.g., zero) may be considered for the import into the RPP at step 202. Additionally or alternatively, demolition jobs (DM) may or may not be considered for the import. Each one of such one or more job numbers may then be utilized for accessing additional job data. Process 300 of FIG. 3 as described below may include certain details with respect to a particular embodiment of at least a portion of step 202 of process 200.

At step 204, process 200 may include attempting to access job data associated with any job number accessed at step 202. For example, for a particular job number accessed at step 202, that job number may be leveraged by RPP coordinator 100 with respect to any suitable data source 10 for accessing any suitable additional data associated with that job number. As just one example, a particular job number of step 202 may be entered into a Building Information Search of DOB data source 12 (e.g., a website or other suitable data portal) and any suitable job page that may be associated with that entered particular job number may be provided by DOB data source 12 and then RPP coordinator 100 may retrieve any suitable job data that may be associated with that particular job number at step 204 (e.g., through extracting job data from the data page provided by the data source using any suitable manual and/or automatic techniques). Such job data that may be accessed at step 204 may be any suitable data that may be associated with a particular job/development, including, but not limited to, job type, job number, pre-filed data, job description, owner's first and/or last name, owner's business name, owner's address (e.g., mailing address, street address, city and state and zip code, etc.), owner's telephone number, owner's e-mail address, proposed number of floors, proposed number of unites, proposed height, proposed square footage, building identification number (BIN), and the like.

If it is determined at step 206 that no suitable job page is found that may be associated with the entered particular job number, then process 200 may proceed to step 207, where a flag may be set in a not found jobs table and associated with any suitable data (e.g., the particular job number and/or the time/date at which that job number was imported at step 202, etc.), where such a table may be reviewed by any suitable entity at any suitable time (e.g., automatically by RPP coordinator 100 and/or by an administrator client device 54). However, if it is determined at step 206 that a suitable job page is found that may be associated with the entered particular job number and the above-described job data is accessed by RPP coordinator 100 (e.g., at step 204), then process 200 may proceed to step 208.

At step 208, process 200 may include attempting to access DOB data associated with any BIN that may be accessed as at least a portion of job data at step 204. For example, for a particular BIN accessed at step 204 as associated with a particular job number accessed at step 202, that BIN may be leveraged by RPP coordinator 100 with respect to any suitable data source 10 for accessing any suitable additional data associated with that BIN. As just one example, a particular BIN of step 204 may be entered into a Building Information Search of DOB data source 12 (e.g., a website or other suitable data portal) and any suitable building data page that may be associated with that entered particular BIN may be provided by DOB data source 12 and then RPP coordinator 100 may retrieve any suitable DOB data that may be associated with that particular BIN at step 208 (e.g., through extracting DOB data from the data page provided by the data source using any suitable manual and/or automatic techniques). Such DOB data that may be accessed at step 208 from such a building data page may be any suitable data that may be associated with a particular job/development, including, but not limited to, a BIN, block information, lot information, main address information, zip code information, borough information, cross-street information, and the like. As just one example, a BIN may be a unique building identification number (e.g., a unique 7-character string) that may be assigned to a particular building by a particular entity (e.g., by any suitable city planning entity, such as the DOB of data source 12), while a job number may be a unique job identification number (e.g., a unique 7-character string) that may be assigned to a particular type of work project with respect to a particular building (e.g., conversion, alteration, new construction with respect to a particular building) by a particular entity (e.g., by any suitable city planning entity, such as the DOB of data source 12), while block information may be a tax block assigned by any suitable entity (e.g., the Department of Finance of data source 16), and/or while lot information may be a tax lot assigned by any suitable entity (e.g., the Department of Finance of data source 16).

If it is determined at step 210 that no suitable building data page is found that may be associated with the entered particular BIN, then process 200 may proceed to step 211, where a flag may be set in a not found BINs table and associated with any suitable data (e.g., the particular job number and/or the time/date at which that job number was imported at step 202 and/or the particular BIN and/or the time/date at which that BIN was accessed at step 204, etc.), where such a table may be reviewed by any suitable entity at any suitable time (e.g., automatically by RPP coordinator 100 and/or by an administrator client device 54). However, if it is determined at step 210 that a suitable building data page is found that may be associated with the entered particular BIN and the above-described DOB data is accessed by RPP coordinator 100 (e.g., at step 208), then process 200 may proceed to step 212.

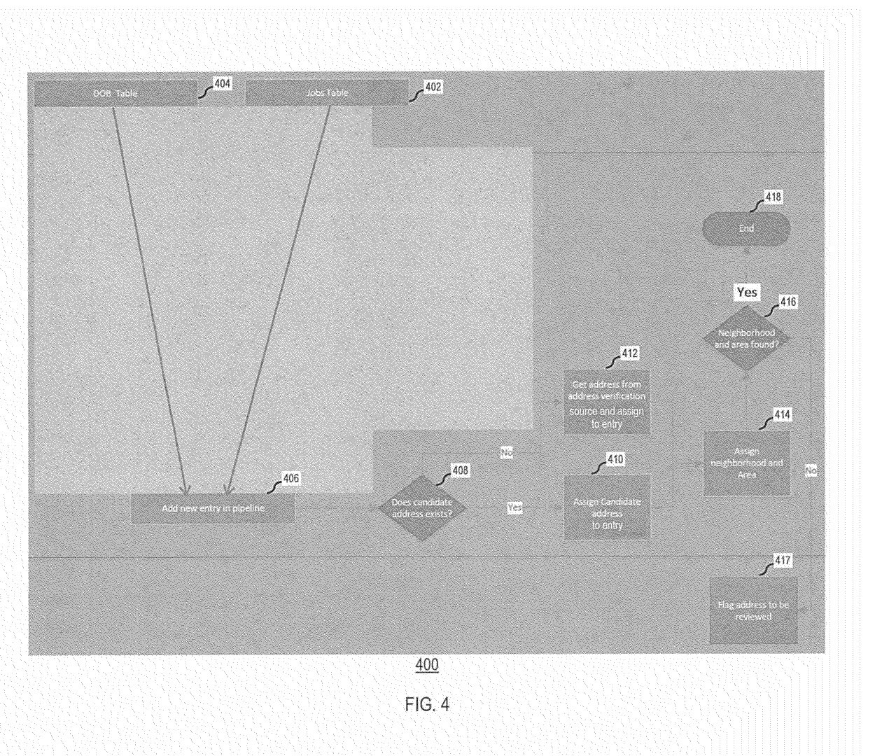

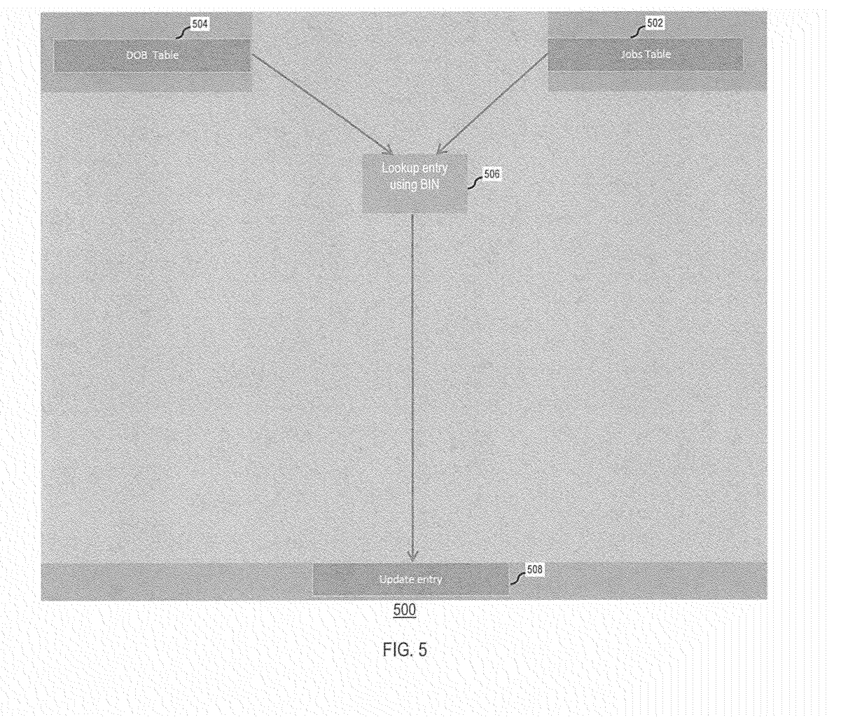

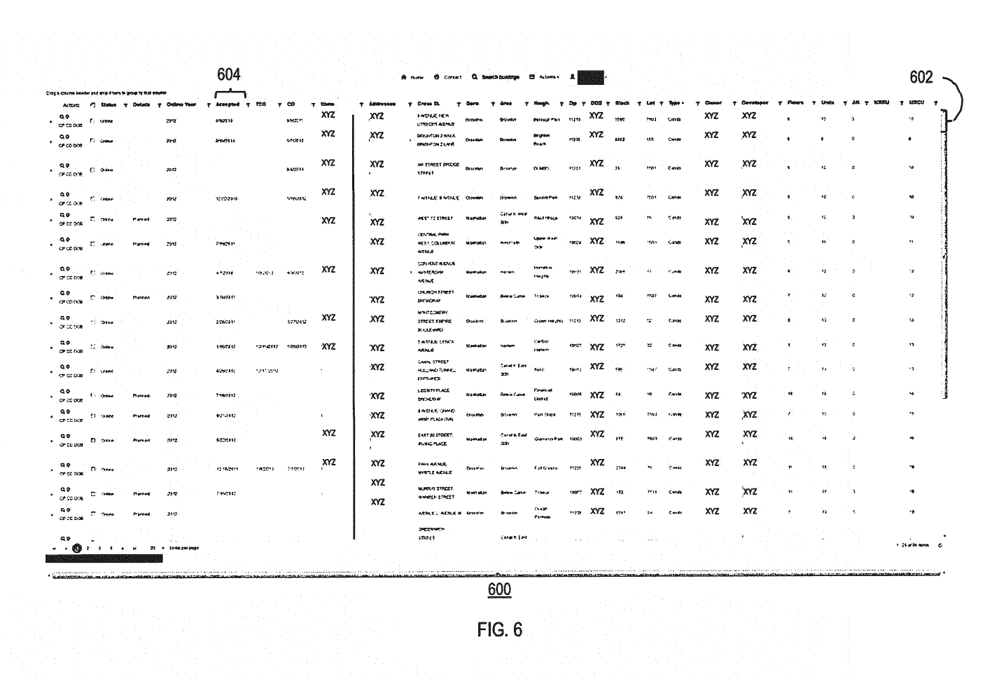

At step 212, process 200 may include attempting to validate the status of the BIN (e.g., the BIN of step 208) using any suitable data (e.g., using the DOB data accessed at step 208). For example, the status of the BIN may be determined to be valid or obsolete by RPP correlator 100 at step 212. If the status of the BIN is determined to be valid at step 212, then process 200 may proceed to step 214 where it may be determined whether that valid BIN already exists in an RPP pipeline database of RPP correlator 100 (e.g., a database that may be shown, in one example, by one or more of FIGS. 6-10). If it is determined at step 214 that the valid BIN does already exist in such an RPP pipeline database, then process 200 may proceed to step 216, where an existing RPP pipeline database entry that includes that valid BIN may be updated with any suitable information, such as any suitable information from the jobs data accessed at step 204 for the particular job number associated with the valid BIN and/or any suitable information from the DOB data accessed at step 208 for the valid BIN. Process 500 of FIG. 5 as described below may include certain details with respect to a particular embodiment of at least a portion of step 216 of process 200. Alternatively, if it is determined at step 214 that the valid BIN does not already exist in such an RPP pipeline database, then process 200 may proceed to step 218, where a new RPP pipeline database entry that includes that valid BIN and any suitable information, such as any suitable information from the jobs data accessed at step 204 for the particular job number associated with the valid BIN and/or any suitable information from the DOB data accessed at step 208 for the valid BIN, may be added to the RPP pipeline database. Process 400 of FIG. 4 as described below may include certain details with respect to a particular embodiment of at least a portion of step 218 of process 200.

If the status of the BIN is determined to be obsolete at step 212, then process 200 may proceed to step 220, where a flag may be set by RPP coordinator 100 at DOB data source 12 with respect to the obsolete BIN. At step 222, process 200 may include attempting to determine if there are any alternate BINs that may be found in the DOB data accessed at step 208 with respect to that obsolete BIN. If no alternate BINs are determined to exist at step 222, then process 200 may proceed to step 223, where a flag may be set for the obsolete BIN in a DOB table and associated with any suitable data (e.g., information indicating that the BIN is obsolete and is not associated with any alternate BINs), where such a table may be reviewed by any suitable entity at any suitable time (e.g., automatically by RPP coordinator 100 and/or by an administrator client device 54). However, if at least one alternate BIN is determined to exist at step 222, then process 200 may proceed to step 224, where it may be determined whether or not any of the at least one identified alternate BINs matches a BIN that already exists in the RPP pipeline database of RPP correlator 100. If it is determined at step 224 that at least one identified alternate BIN does already exist in such an RPP pipeline database, then process 200 may proceed to step 226, where it may be determined whether more than one identified alternate BIN does already exist in such an RPP pipeline database. If it is determined at step 226 that more than one identified alternate BIN does already exist in the RPP pipeline database, then process 200 may proceed to step 227, where a flag may be set for a DOB entry to determine (e.g., automatically or manually) which one of the more than one identified alternate BINs ought to be used for potentially updating an existing entry of the RPP pipeline database (e.g., at step 216). However, if it is determined at step 226 that only one identified alternate BIN already exists in the RPP pipeline database, then process 200 may proceed to step 216, where an existing RPP pipeline database entry that includes that alternate BIN may be updated with any suitable information, such as any suitable information from the jobs data accessed at step 204 for the particular job number associated with the obsolete BIN associated with the alternate BIN and/or any suitable information from the DOB data accessed at step 208 for the obsolete BIN associated with the alternate BIN. However, if it is determined at step 224 that none of the at least one identified alternate BIN already exist in such an RPP pipeline database, then process 200 may proceed to step 228, where it may be determined whether more than one alternate BIN has been identified. If it is determined at step 228 that more than one alternate BIN has been identified, then process 200 may proceed to step 227, where a flag may be set for a DOB entry to determine (e.g., automatically or manually) which one or more of the more than one identified alternate BINs ought to be used for potentially updating an existing entry of the RPP pipeline database (e.g., at step 216). However, if it is determined at step 228 that only one alternate BIN has been identified, then process 200 may proceed to step 218, where a new RPP pipeline database entry that includes that alternate BIN and any suitable information, such as any suitable information from the jobs data accessed at step 204 for the particular job number associated with the obsolete BIN associated with the alternate BIN and/or any suitable information from the DOB data accessed at step 208 for the obsolete BIN associated with the alternate BIN, may be added to the RPP pipeline database.

One or more of steps 202, 204, 206, 208, and/or 210 may be associated with RPP coordinator 100 accessing external data from one or more data sources (e.g., data source(s) 10) remote from RPP coordinator 100. Additionally or alternatively, one or more of steps 212, 214, 216, 218, 220, 222, 224, 226, and/or 228 may be associated with RPP coordinator 100 importing, washing, updating, and/or creating data entries to an RPP pipeline database. Additionally or alternatively, one or more of steps 207, 211, 223, and/or 227 may be associated with administration of RPP coordinator 100 (e.g., an administrator entity (e.g., of administrator client device 54) being leveraged to manually and/or automatically process flagged items for making process 200 more effective and/or more efficient). It is understood that the steps shown in process 200 of FIG. 2 are merely illustrative and that existing steps may be modified or omitted, additional steps may be added, and the order of certain steps may be altered.

FIG. 2A is a flowchart of an illustrative process 250 for managing pipeline data (e.g., as may be carried out by the RPP (e.g., by RPP coordinator 100 of system 1)). At step 252, process 250 may include importing pipeline data from a data source. For example, step 252 may include RPP coordinator 100 importing (e.g., downloading, such as via push techniques or via pull techniques) pipeline job data from any suitable data source 10, such as from the Department of Buildings (DOB) data source 12 (e.g., as a part of a NY city feed). Such pipeline job data may be any suitable data, such as basic jobs data or jobs basic data (e.g., a Jobs Report as may be provided as an update in the NYC OpenData database). RPP coordinator 100 may be communicatively coupled to the appropriate data source for downloading such pipeline data at any suitable time (e.g., daily, weekly, when any new data is available, etc.). Continuing with a particular example where jobs basic data may be imported at step 252, such jobs basic data may include one or more job numbers that may be associated with one or more developments in the pipeline. For the import of step 252, various thresholds or characteristics may be used to limit the types of jobs that are imported. For example, only new building (NB) jobs with a specified threshold number of proposed dwelling units (e.g., at least 4) may be considered for the import into the RPP at step 252. Additionally or alternatively, alteration 1 (A1) jobs with a specified threshold number of proposed dwelling units (e.g., at least 4) and a specified threshold number of existing dwelling units (e.g., zero) may be considered for the import into the RPP at step 252. Additionally or alternatively, demolition jobs (DM) may or may not be considered for the import. Each one of such one or more job numbers may then be utilized for accessing additional job data. Process 300 of FIG. 3 as described below may include certain details with respect to a particular embodiment of at least a portion of step 252 of process 250.

At step 254, process 250 may include attempting to access detailed jobs data or jobs detailed data that may be associated with any job number accessed at step 252. For example, for a particular job number accessed at step 252, that job number may be leveraged by RPP coordinator 100 with respect to any suitable data source 10 for accessing any suitable additional data associated with that job number (e.g., as jobs detailed data). As just one example, a particular job number of step 252 may be entered into a Building Information Search of DOB data source 12 (e.g., a website or other suitable data portal) and any suitable job page that may be associated with that entered particular job number may be provided by DOB data source 12 and then RPP coordinator 100 may retrieve any suitable jobs detailed data that may be associated with that particular job number at step 254 (e.g., through extracting jobs detailed data from the job data page provided by the data source using any suitable manual and/or automatic techniques). Such jobs detailed data that may be accessed at step 254 may be any suitable data that may be associated with a particular job/development, including, but not limited to, job type, job number, pre-filed data, job description, owner's first and/or last name, owner's business name, owner's address (e.g., mailing address, street address, city and state and zip code, etc.), owner's telephone number, owner's e-mail address, proposed number of floors, proposed number of unites, proposed height, proposed square footage, building identification number (BIN), and the like.

If it is determined at step 256 that no suitable job page is found that may be associated with the entered particular job number, then process 250 may proceed to step 257, where a flag may be set in a not found jobs table and associated with any suitable data (e.g., the particular job number and/or the time/date at which that job number was imported at step 252, etc.), where such a table may be reviewed by any suitable entity at any suitable time (e.g., automatically by RPP coordinator 100 and/or by an administrator client device 54). However, if it is determined at step 256 that a suitable job page is found that may be associated with the entered particular job number and the above-described job data is accessed by RPP coordinator 100 (e.g., at step 254), then process 250 may proceed to step 258.

At step 258, process 250 may include attempting to access DOB data associated with any BIN that may be accessed as at least a portion of jobs detailed data at step 254. For example, for a particular BIN accessed at step 254 as associated with a particular job number accessed at step 252, that BIN may be leveraged by RPP coordinator 100 with respect to any suitable data source 10 for accessing any suitable additional data associated with that BIN. As just one example, a particular BIN of step 254 may be entered into a Building Information Search of DOB data source 12 (e.g., a website or other suitable data portal) and any suitable building data page that may be associated with that entered particular BIN may be provided by DOB data source 12 and then RPP coordinator 100 may retrieve any suitable DOB building data that may be associated with that particular BIN at step 258 (e.g., through extracting DOB data from the data page provided by the data source using any suitable manual and/or automatic techniques). Such DOB building data that may be accessed at step 258 from such a building data page may be any suitable data that may be associated with a particular job/development, including, but not limited to, a BIN, block information, lot information, main address information, zip code information, borough information, cross-street information, and the like. As just one example, a BIN may be a unique building identification number (e.g., a unique 7-character string) that may be assigned to a particular building by a particular entity (e.g., by any suitable city planning entity, such as the DOB of data source 12), while a job number may be a unique job identification number (e.g., a unique 7-character string) that may be assigned to a particular type of work project with respect to a particular building (e.g., conversion, alteration, new construction with respect to a particular building) by a particular entity (e.g., by any suitable city planning entity, such as the DOB of data source 12), while block information may be a tax block assigned by any suitable entity (e.g., the Department of Finance of data source 16), and/or while lot information may be a tax lot assigned by any suitable entity (e.g., the Department of Finance of data source 16).

If it is determined at step 260 that no suitable building data page is found that may be associated with the entered particular BIN or that no BIN is found, then process 250 may proceed to step 261, where a flag may be set in a not found BINs table and associated with any suitable data (e.g., the particular job number and/or the time/date at which that job number was imported at step 252 and/or the particular BIN and/or the time/date at which that BIN was accessed at step 254, etc.), where such a table may be reviewed by any suitable entity at any suitable time (e.g., automatically by RPP coordinator 100 and/or by an administrator client device 54). However, if it is determined at step 260 that a suitable building data page is found that may be associated with the entered particular BIN and the above-described DOB building data is accessed by RPP coordinator 100 (e.g., at step 258), then process 250 may proceed to step 262.

At step 262, process 250 may include creating and/or updating a unique group identifier (group ID) of the RPP that may be associated with each group of BINs that may be associated with a particular building (e.g., each BIN used at each iteration of step 258 for a particular building or job number or other suitable identification). If such a group is determined to be represented by a group ID at step 264, then process 250 may proceed to step 266, where it may be determined if an RPP pipeline database entry associated with that group ID is locked (e.g., by an administrator entity associated with the RPP). If it is determined at step 266 that the entry is not locked, process 250 may proceed to step 268, where that entire entry may be updated (e.g., as described with respect to step 216 of process 200). However, if it is determined at step 266 that the entry is locked, process 250 may proceed to step 270, where only any unlocked fields of that entry may be updated. If such a group is determined not to be represented by a group ID at step 264, then process 250 may proceed to step 272, where it may be determined whether the group ID meets any or all requirements of the RPP (e.g., by analyzing one or more of the BINs associated with that group ID (e.g., as described with respect to one or more of steps 212, 214, 220, 222, 223, 224, 226, 227, and/or 228). If it is determined at step 272 that one or more requirements are not met, then process 250 may proceed to step 276, where the particular job associated with the particular job number (e.g., the particular job number used at step 254 for the current iteration of process 250) may be ignored. However, if it is determined at step 272 that one or more requirements are met, then process 250 may proceed to step 274, where a new RPP pipeline database entry associated with that group ID may be created (e.g., using appropriate job data and/or DOB building data, such as described with respect to step 218 of process 200).

One or more of steps 252, 254, 256, 258, and/or 260 may be associated with RPP coordinator 100 accessing external data from one or more data sources (e.g., data source(s) 10) remote from RPP coordinator 100. Additionally or alternatively, one or more of steps 262, 264, 266, 268, 270, 272, 274, and/or 276 may be associated with RPP coordinator 100 importing, washing, updating, and/or creating data entries to an RPP pipeline database. Additionally or alternatively, one or more of steps 257 and/or 261 may be associated with administration of RPP coordinator 100 (e.g., an administrator entity (e.g., of administrator client device 54) being leveraged to manually and/or automatically process flagged items for making process 250 more effective and/or more efficient). It is understood that the steps shown in process 250 of FIG. 2A are merely illustrative and that existing steps may be modified or omitted, additional steps may be added, and the order of certain steps may be altered.

FIG. 3 is a flowchart of an illustrative process 300 for a particular embodiment of importing pipeline data from a data source, which may be similar to an embodiment of step 202 of process 200 and/or of step 252 of process 250. For example, step 302 of process 300 may include RPP coordinator 100 importing (e.g., downloading, such as via push techniques or via pull techniques) pipeline job data from any suitable data source 10, such as from the Department of Buildings (DOB) data source 12. Such pipeline job data may be any suitable data, such as a jobs report from the DOJ (e.g., a Jobs Report as may be provided as an update in the NYC OpenData database), and may be in any suitable formal, such as an Excel spreadsheet. RPP coordinator 100 may be communicatively coupled to the appropriate data source for downloading such pipeline data at any suitable time (e.g., daily, weekly, when any new data is available, etc.). At step 304, process 300 may include determining whether the structure of the pipeline data recently imported at step 302 is the same as the structure of the pipeline data imported at a previous iteration of step 302 prior to the last iteration of step 302. If it is determined at step 304 that the structures are the same, then process 300 may proceed to step 306, where the most recently imported pipeline data may be downloaded into a jobs table at RPP coordinator 100 (e.g., where the various downloaded job types may include NB jobs, A1 jobs, DM jobs, and/or the like). However, if it is determined at step 304 that the structures are not the same, then process 300 may proceed to step 308, where any suitable message may be sent to any suitable administrator (e.g., to an entity that may be in control of administrator client device 54) that may be indicative of the fact that the structure of the most recently imported pipeline data is not the same as the structure of the previously imported pipeline data, such that the most recently imported pipeline data may be processed in one or more additional ways to most effectively handle any relevant information therein. Step 302 may be associated with RPP coordinator 100 accessing external data from one or more data sources (e.g., data source(s) 10) remote from RPP coordinator 100. Additionally or alternatively, one or more of steps 304 and/or 306 may be associated with RPP coordinator 100 importing, washing, updating, and/or creating data entries to an RPP pipeline database or otherwise handling any suitable data related thereto. Additionally or alternatively, step 308 may be associated with administration of RPP coordinator 100 (e.g., an administrator entity (e.g., of administrator client device 54) being leveraged to manually and/or automatically process flagged items for making process 300 more effective and/or more efficient). It is understood that the steps shown in process 300 of FIG. 3 are merely illustrative and that existing steps may be modified or omitted, additional steps may be added, and the order of certain steps may be altered.

FIG. 4 is a flowchart of an illustrative process 400 for a particular embodiment of creating a new entry in an RPP pipeline database, which may be similar to an embodiment of step 218 of process 200 and/or of step 274 of process 250. For example, step 402 of process 400 may include accessing any suitable job data from any suitable data source (e.g., from DOB data source 12) as described above with respect to step 204 of process 200 (e.g., for downloading into a jobs table), while step 404 of process 400 may include accessing any suitable DOB data from any suitable data source (e.g., from DOB data source 12) as described above with respect to step 208 of process 200 (e.g., for downloading into a DOB table). Then, at step 406, process 400 may include adding any suitable job data from step 402 and/or any suitable DOB data from step 404 into a new entry in the RPP pipeline database. At step 408, it may be determined whether any suitable candidate address exists for this newly created entry. If it is determined that a suitable candidate address does exist at step 408, then process 400 may proceed to step 410, where the candidate address may be assigned to that newly created entry. However, if it is determined that a suitable candidate address does not exist at step 408, then process 400 may proceed to step 412, where a suitable address for the newly created entry may be accessed by the RPP (e.g., using any suitable address verification data source 10 (e.g., SmartyStreets, United States Postal Service, etc.)) and then assigning that accessed address to the newly created entry. After either step 410 or step 412, process 400 may proceed to step 414, where any suitable neighborhood information and/or any suitable area information may be assigned to the newly created entry based on its assigned address. For example, with respect to identifying and assigning area and/or neighborhood and/or borough and/or any other suitable geographic information to a newly created entry, global positioning system (GPS) coordinates or any other suitable geographic information of the address information of steps 408-412 may be leveraged. By using the address and zip code, the RPP may identify the smallest shape that the location is within (e.g., neighborhood), and may then know which area and borough that neighborhood is within. Therefore, a user may not have to manually enter in this information, unless it is a manually added building without address and/or zip code information. Next, at step 416, it may be determined whether any suitable neighborhood and/or area information was assigned at step 414. If so, process 400 may proceed from step 416 to step 418 and end. Otherwise, process 400 may proceed from step 416 to step 417, where the address may be flagged for further review by any suitable entity at any suitable time (e.g., automatically by RPP coordinator 100 and/or by an administrator client device 54). One or more of steps 402 and/or 404 may be associated with RPP coordinator 100 accessing external data from one or more data sources (e.g., data source(s) 10) remote from RPP coordinator 100. Additionally or alternatively, one or more of steps 406, 408, 410, 412, 414, and/or 416 may be associated with RPP coordinator 100 importing, washing, updating, and/or creating data entries to an RPP pipeline database or otherwise handling any suitable data related thereto. Additionally or alternatively, step 417 may be associated with administration of RPP coordinator 100 (e.g., an administrator entity (e.g., of administrator client device 54) being leveraged to manually and/or automatically process flagged items for making process 400 more effective and/or more efficient). It is understood that the steps shown in process 400 of FIG. 4 are merely illustrative and that existing steps may be modified or omitted, additional steps may be added, and the order of certain steps may be altered.

FIG. 5 is a flowchart of an illustrative process 500 for a particular embodiment of updating an existing entry in an RPP pipeline database, which may be similar to an embodiment of step 216 of process 200 and/or of step 268 and/or step 270 of process 250. For example, step 502 of process 500 may include accessing any suitable job data from any suitable data source (e.g., from DOB data source 12) as described above with respect to step 204 of process 200 (e.g., for downloading into a jobs table), while step 504 of process 500 may include accessing any suitable DOB data from any suitable data source (e.g., from DOB data source 12) as described above with respect to step 208 of process 200 (e.g., for downloading into a DOB table). Then, at step 506, process 500 may include identifying an existing entry in the RPP pipeline database using a BIN from at least one of the job data of step 502 and/or the DOB data of step 504 (e.g., as described above with respect to steps 210-226 of process 200). At step 508, process 500 may include updating the identified existing entry with any suitable job data from step 502 and/or any suitable DOB data from step 504. One or more of steps 502 and/or 504 may be associated with RPP coordinator 100 accessing external data from one or more data sources (e.g., data source(s) 10) remote from RPP coordinator 100. Additionally or alternatively, one or more of steps 506 and/or 508 may be associated with RPP coordinator 100 importing, washing, updating, and/or creating data entries to an RPP pipeline database or otherwise handling any suitable data related thereto. It is understood that the steps shown in process 500 of FIG. 5 are merely illustrative and that existing steps may be modified or omitted, additional steps may be added, and the order of certain steps may be altered.

### Detailed Description of an Rpp Pipeline Database

FIG. 6 shows a screen shot diagram 600 illustrating an exemplary view of at least a portion of an illustrative RPP pipeline database that may include one or more entries 602. Each entry 602 may include one or more suitable pieces of data of any suitable type related to a particular job/development in one or more fields 604, including, but not limited to, type (e.g., status), details, online year, CD offering accepted date, TCO/effective date (TCO), CO/effective date (CO), building name, known address(es), cross-street(s), borough, area, neighborhood, zip code, BIN (DOB #), building block, building lot, square footage, unit type, owner's business name, owner's business contact information (e.g., address, telephone number, e-mail address, etc.), number of floors, number of units, number of affordable units, number of market rate rental units (MRRUs), number of market rate condo units (MRCUs), and/or any other suitable information, which may be accessed by RPP correlator 100 from any suitable jobs data accessed at step 204 and/or from any suitable DOB data accessed at step 208 or otherwise. For example, at least one entry 602 of an RPP pipeline database may include a field with at least some missing information that may not be provided from any suitable jobs data accessed at step 204 and/or from any suitable DOB data accessed at step 208. Therefore, process 200 may include any other suitable steps for obtaining any additional suitable information for supplementing one or more entries 602. For example, with respect to borough, area, and/or neighborhood fields, certain conditions for these three types may be created using global positioning system (GPS) coordinates or any other suitable geographic information. By using the address and zip code, the RPP may identify the smallest shape that the location is within (neighborhood), and may then know which area and borough that neighborhood is within. Therefore, a user may not have to manually enter in this information, unless it is a manually added building without address and/or zip code. With respect to unit type field information, actual use may be determined from journalism (e.g., from data from a commercial data source 18), such as where a developer may have publicly announced what type of development was planned. In another embodiment, actual use (e.g., condominium and co-op use) may be determined from the filing of an offering plan with the Attorney General's (AG) office (e.g., as accessible from data from data source 14). Once such a filing is submitted, the unit type may be automatically changed. The data from the AG's office may be utilized to make this determination. In yet another embodiment, actual use (e.g., rental) may be determined by analyzing rental listings (e.g., seen on any suitable public database of data source 10). With respect to market rate unit type field information, the number of market rate units may be determined from journalism (e.g., from data from a commercial data source 18), where a developer may have announced the number of market rate units and/or the number of affordable units planned. In another embodiment, the number of market rate units may be assumed to be 100%. With respect to affordable unit field information, may be determined to be the total number of units for a job minus the market rate units for that job if the job is rental, condo, or the like. With respect to online year/projected online year field information, such information may be accessed from an Attorney General's Offering Plan Database (e.g., from data source 14), whereas once an offering plan is accepted in the AG's database, the RPP may use this data as its “Online Date”. This may be used for condominiums and co-ops. The RPP may also extract or otherwise access data indicative of the “Type” to determine condo versus coop. Additionally or alternatively, certificates of occupancy data may be accessed from the DOB (e.g., from data source 12), where the effective date of the first temporary certificate of occupancy may be used as the online date for rental buildings. In some cases, particularly with smaller buildings, there may not be temporary certificates of occupancy, and the effective date of a final certificate of occupancy may be used as the online date. Additionally or alternatively, with respect to projection, when a building first enters the pipeline, the previous two documents may not apply as it may be too early in the process. In this case, the RPP may apply a standard to project the online date based on one or more of a job pre-filed date, units, height, and/or neighborhood. With respect to status field information, if there is an NB or an A1 job type, the status may be tagged as “Under Construction.” If not, the status may be tagged as “Planned.” With respect to construction/conversion field information, if the building is added because of an NB job, the RPP may tag it as “Construction.” If added because of an A1, the RPP may tag it as “Conversion.” With respect to service level field information, the RPP may determine an attended/unattended service level utilizing an available public database. With respect to sold/rented out date field information, such information may be obtained through journalism (e.g., from data from a commercial data source 18) and/or inquiries (e.g., emails, phone calls, etc.) to each building (e.g., to its owner, etc.).

Screen shot diagram 600 of FIG. 6 illustrating an exemplary view of at least a portion of an illustrative RPP pipeline database may be indicative of a view of the RPP pipeline database as may be made available to a user client (e.g., to user client device 52) with a “search buildings” tab activated. The column headings for each field 604 may be sorted alphabetically or numerically or in any other suitable fashion (e.g., based on the type of information in that field being sorted), and/or such data may be filtered in any suitable manner. This may allow a user to customize any search with respect to the RPP pipeline database (e.g., as may be managed by process 200). Such customizable searches may be saved to a particular user's “profile” of the RPP and may be reused. The headers of each column field may be customizable themselves, so if there is a certain set of data fields that the user would like to view, they may select or deselect each data field. These column fields may be widened or shortened for viewing purposes. As shown, each entry 602 may include one or more actions in an associated action field, that may include, but is not limited to, a magnifying glass that may be linked to a search engine's results for the entry's address, a map marker that may be linked to a map application pointed towards the entry's address, a “CP” marker that may be linked to the building's page in the AG's data store 14 (e.g., if a CP offering plan was filed), a “CD” marker that may be linked to the building's page in the AG's data store 14 (e.g., if a CD offering plan was filed), a “DOB” marker that may be linked to the building's page in the DOB's data store 12, a sideways triangle or “expand” marker that may be clicked or otherwise interacted with to drop down an entry menu that may include various amounts and types of information that may be associated with that entry.

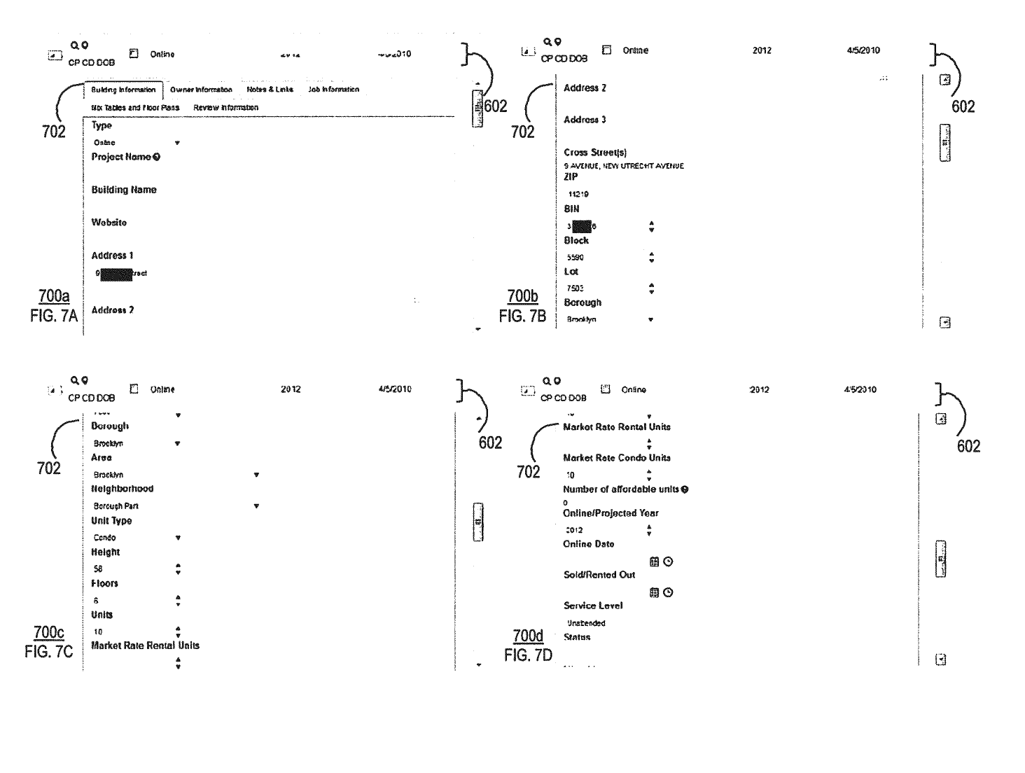

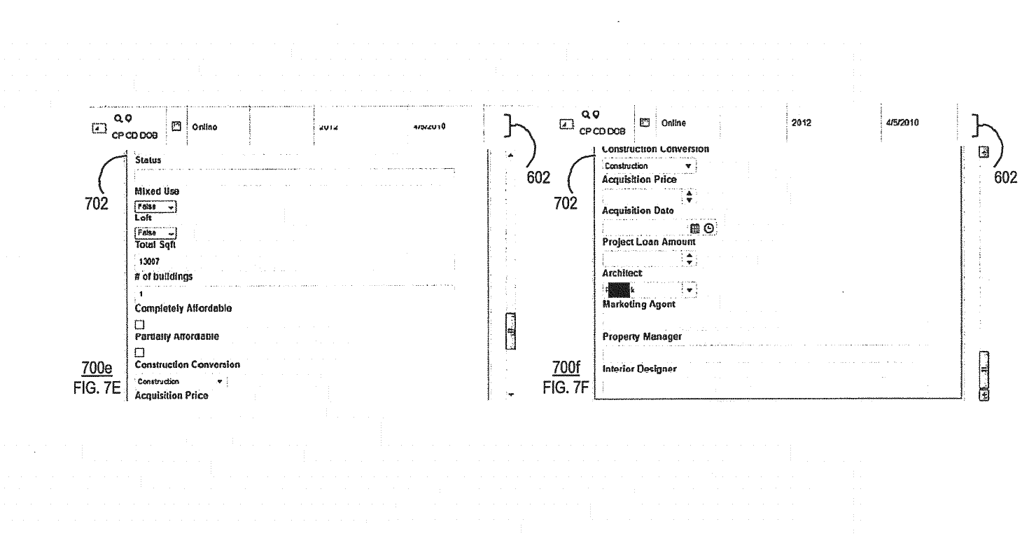

For example, as shown in FIGS. 7A-7F, various respective portions 700a-700f of a particular building information tab 702 of an entry menu of a particular entry 602 of the RPP pipeline database may include various types of data, including, but not limited to, type, project name, building name. website, address 1-3, cross-street(s), zip code, BIN, block, lot, borough, area, neighborhood, unit type, height, floors, unites, MRRUs, MRCUs, number of available units, online/projected year, online date, sold/rented out, service level, status, mixed use, loft, total square feet, number of buildings, affordable, partially affordable, construction conversion, acquisition price, acquisition date, project loan amount, architect, marketing agent, property manager, and/or interior designer fields, one or more of which may be automatically defined (e.g., by process 200) and/or which may be manually defined by a user or administrator

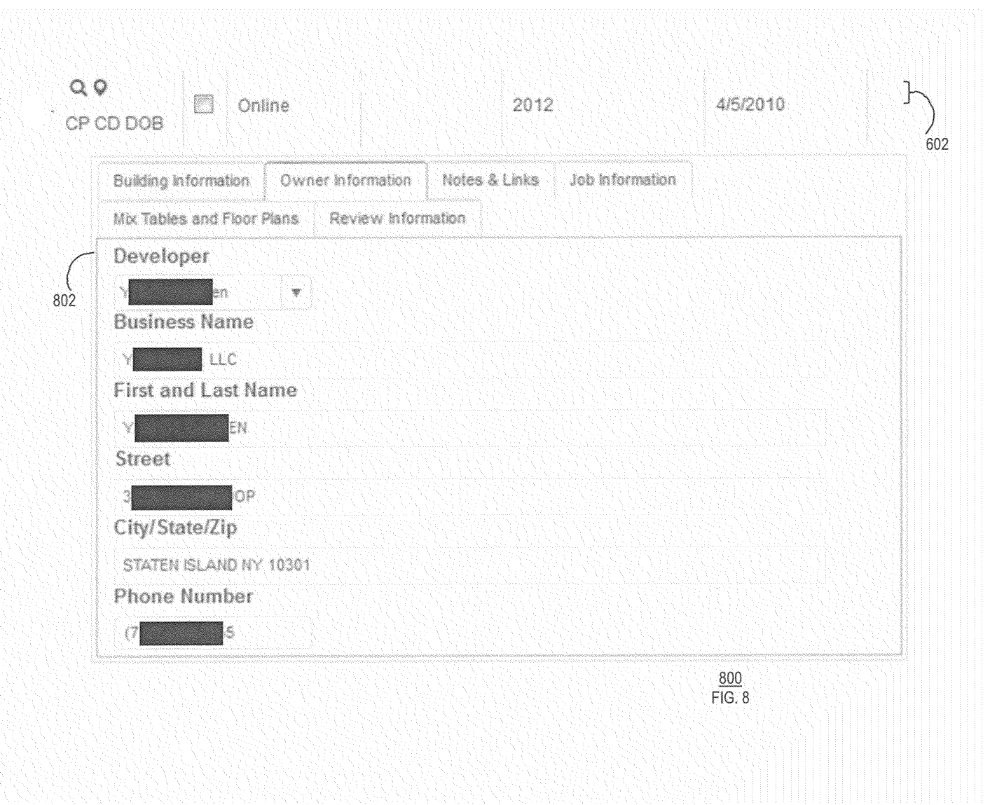

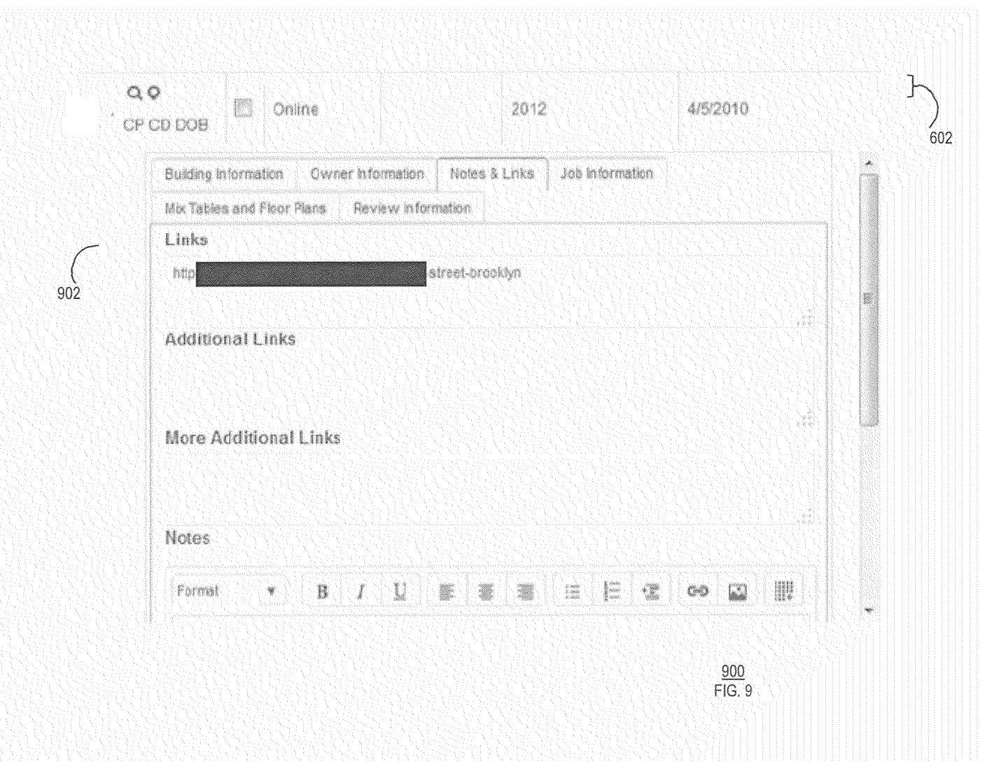

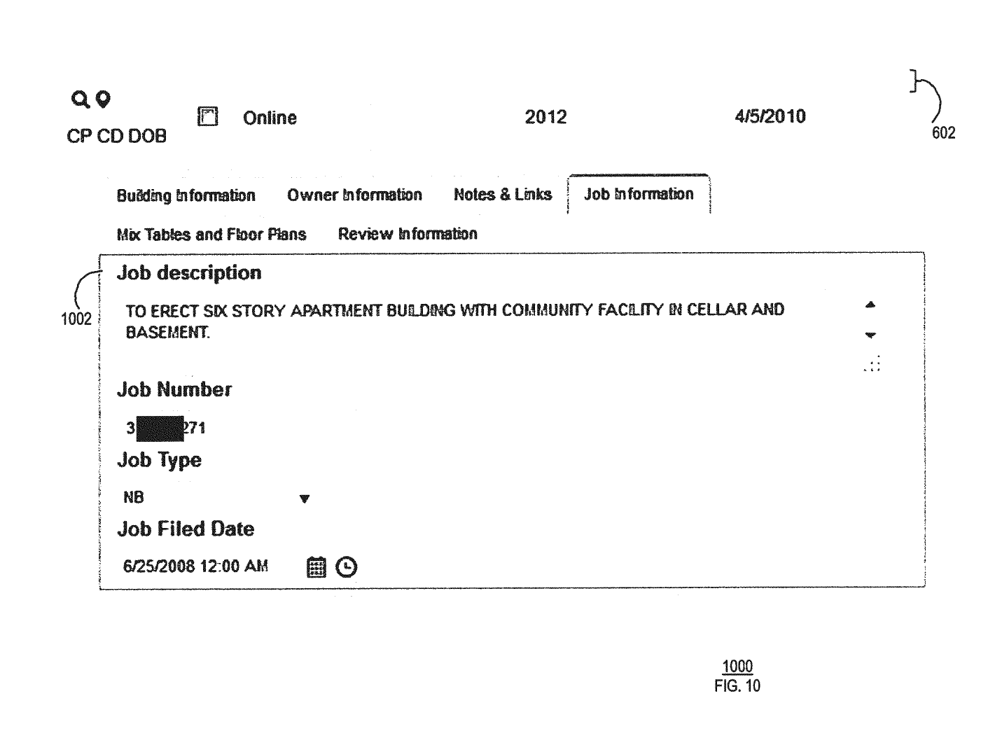

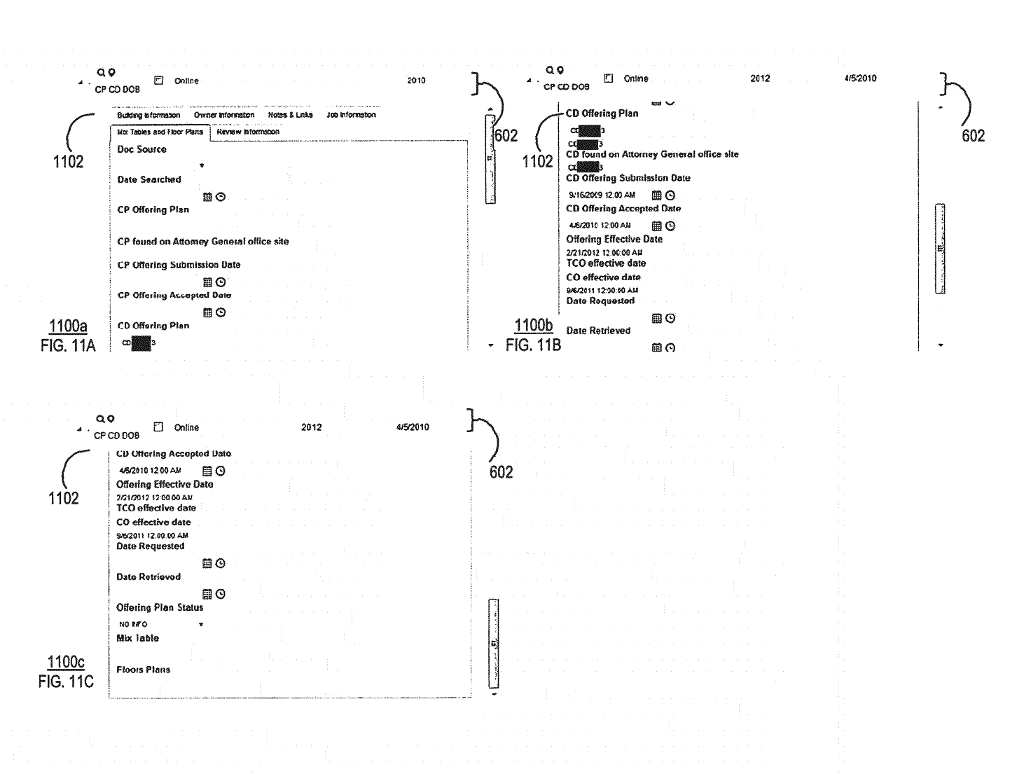

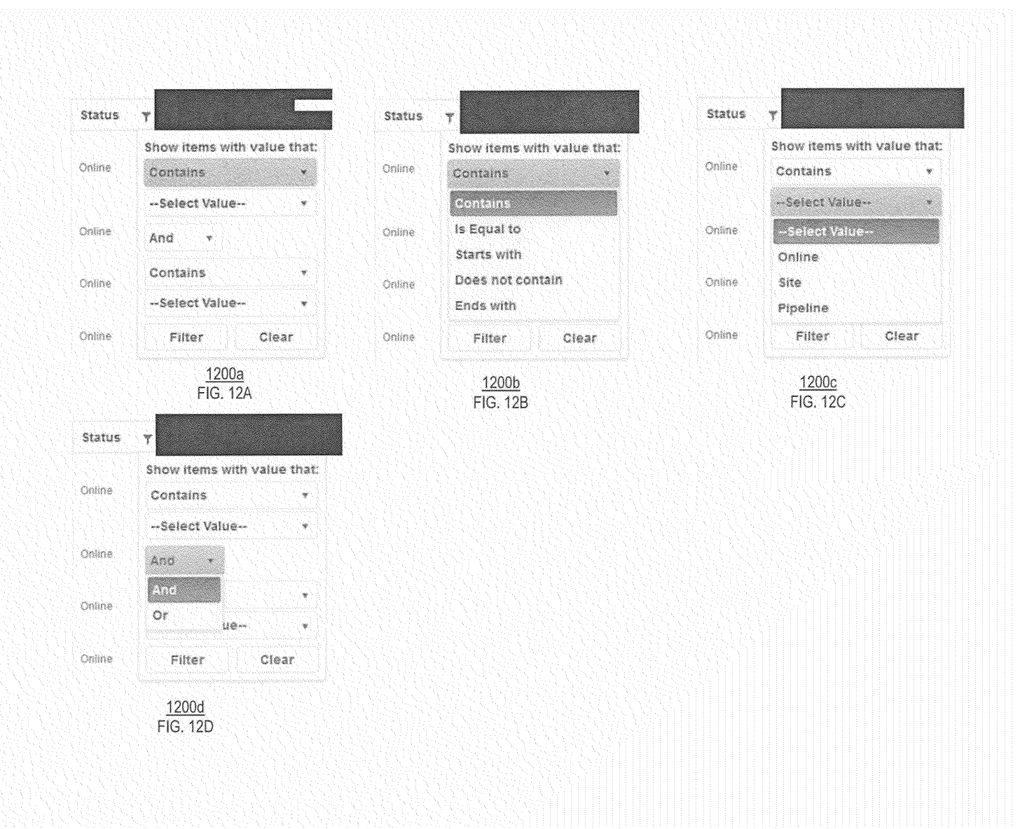

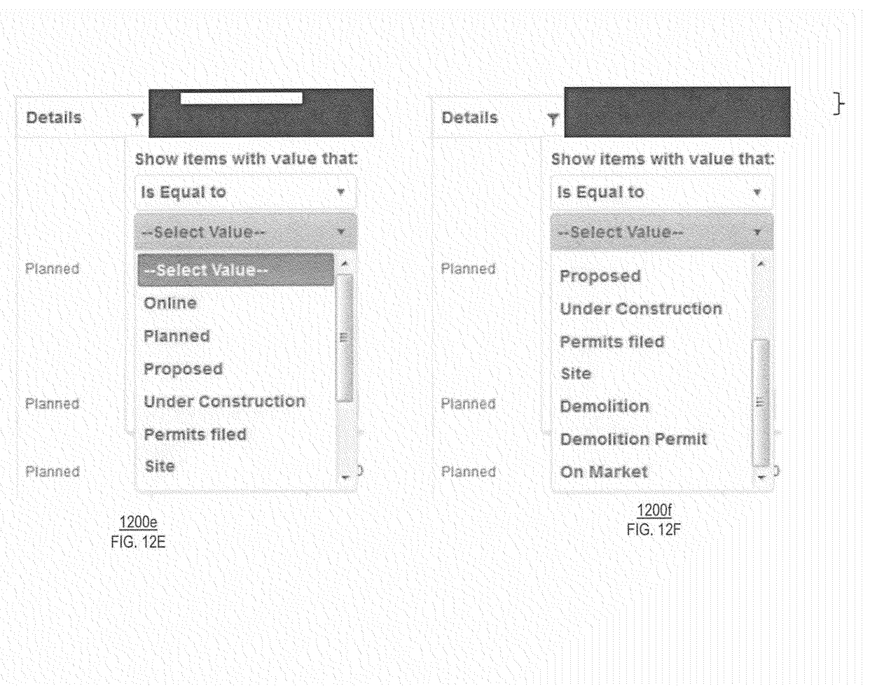

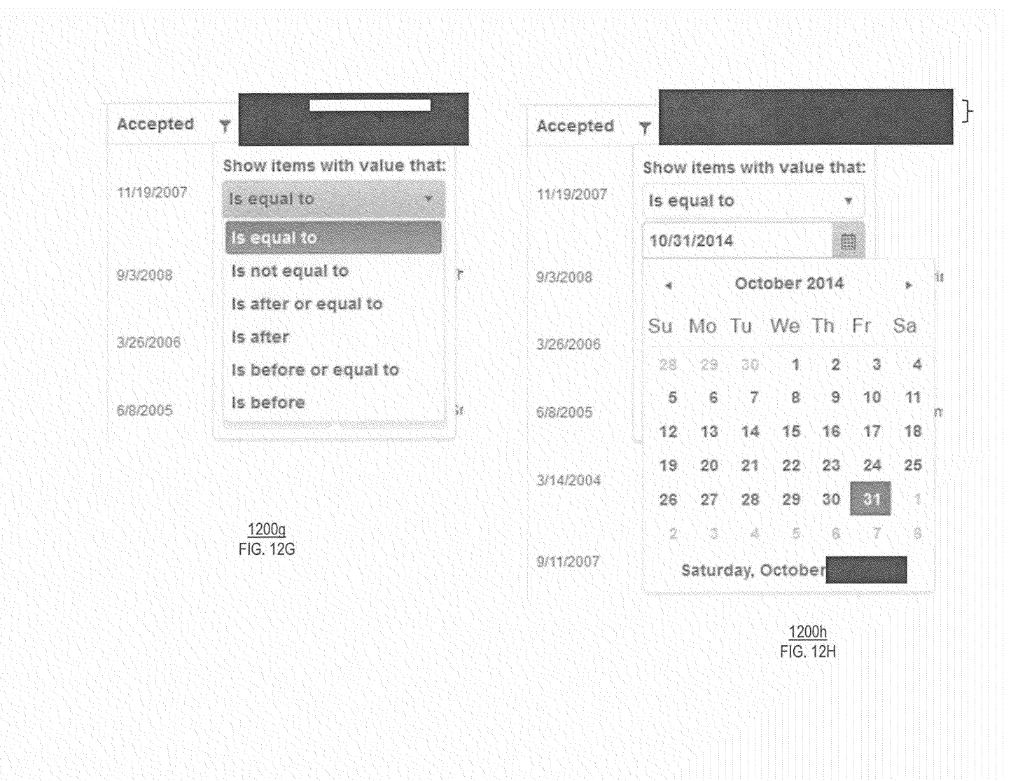

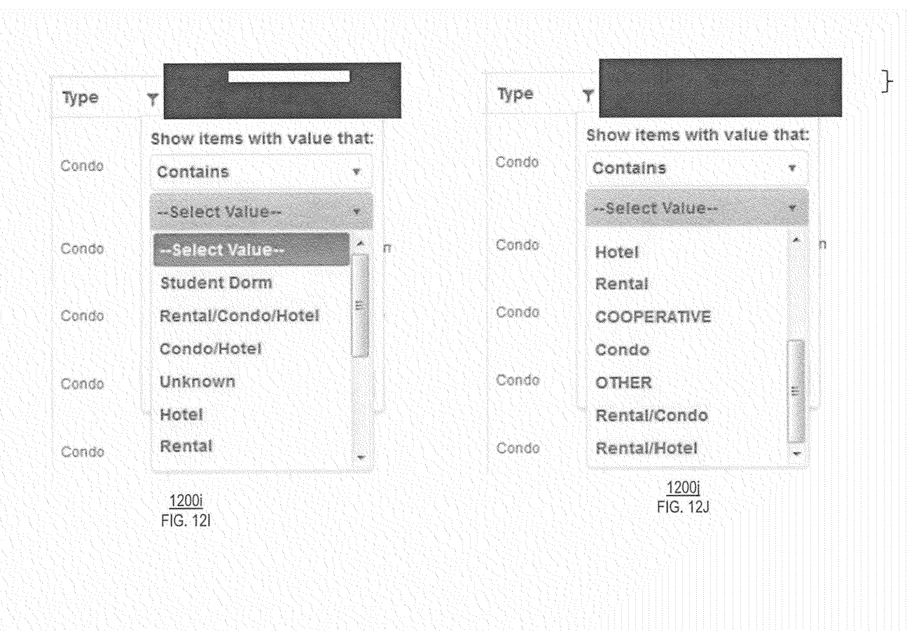

Additionally or alternatively, as shown in FIG. 8, screen shot diagram 800 of a particular owner information tab 802 of an entry menu of a particular entry 602 of the RPP pipeline database may include various types of data, including, but not limited to, developer, business name, first and last name, street, city/state/zip, telephone number, and/or any other suitable owner information fields, one or more of which may be automatically defined (e.g., by process 200) and/or which may be manually defined by a user or administrator. Additionally or alternatively, as shown in FIG. 9, screen shot diagram 900 of a particular notes and links tab 902 of an entry menu of a particular entry 602 of the RPP pipeline database may include various types of data, including, but not limited to, a links field, an additional links field, a more additional links field, and/or a notes field, and/or any other suitable information fields, one or more of which may be automatically defined (e.g., by process 200) and/or which may be manually defined by a user or administrator. Additionally or alternatively, as shown in FIG. 10, screen shot diagram 1000 of a particular job information tab 1002 of an entry menu of a particular entry 602 of the RPP pipeline database may include various types of data, including, but not limited to, a job description field, a job number field, a job type field, a job filed date field, and/or any other suitable information fields, one or more of which may be automatically defined (e.g., by process 200) and/or which may be manually defined by a user or administrator. Additionally or alternatively, as shown in FIGS. 11A-11C, screen shot diagrams 1100a-100c of a particular mix tables and floor plans tab 1102 of an entry menu of a particular entry 602 of the RPP pipeline database may include various types of data, including, but not limited to, a doc source field, a date searched field, a CP offering plan field, a CP found on AG office site field, a CP offering submission field, a CP offering accepted date field, a CD offering plan field, a CD found on AG office site field, a CD offering submission field, a CD offering accepted date field, an offering effective date field, a TCO effective date field, a CO effective date field, a date requested field, a date retrieved field, an offering plan status field, a mix table field, a floor plan field, and/or any other suitable information fields, one or more of which may be automatically defined (e.g., by process 200) and/or which may be manually defined by a user or administrator. Additionally or alternatively, as shown in FIG. 12, screen shot diagram 1200 of a particular review information tab 1202 of an entry menu of a particular entry 602 of the RPP pipeline database may include various types of data, including, but not limited to, a created by field, a created date field, an updated by field, a daily update field, a date reviewed field, a full review field, a full reviewed by field, and/or any other suitable information fields, one or more of which may be automatically defined (e.g., by process 200) and/or which may be manually defined by a user or administrator. Therefore, any such data fields may be updated automatically by the RPP in light of any new data accessed with respect to a particular entry (e.g., during an iteration of process 200) and/or manually by a client device, such that invaluable information may be conveniently and efficiently and effectively made available to any suitable user.

Moreover, besides the “search buildings” tab of FIG. 6, a “reports” tab may be selected that may be operative to enable fully customizable report generation, such as by location, unit type, size, developer, and/or the like. Total entries may be presented to show the total number of buildings or jobs for a particular search of the RPP pipeline database. Any suitable report may be exported into a spreadsheet (e.g., an Excel file) for manipulation or into a PDF file (e.g., for printing purposes). Any report may be filtered or arranged by any suitable fields, such as classification, borough, area, neighborhood, unit type, and the like. The RPP may be operative to generate and share a daily communication (e.g., e mail) update with a user for any particular projects. For example, if the user has a particular area or developer of interest, such communications may be customized to that user's specifications. Additionally or alternatively, the RPP may provide a comment section for a user to leave notes. The user may select which users within their network can see such comments.

FIGS. 12A-12J show other embodiments of an interface that may be provided by the RPP to a client device.

### The Embodiments of the RPP

The entirety of this disclosure (including the written description, figures, claims, abstract, appendices, and/or the like) for RESIDENTIAL PIPELINE PLATFORM METHODS, APPARATUSES AND MEDIA shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the RPP coordinator, RPP coordinator elements, RPP data stores, RPP components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the RPP coordinator, RPP coordinator elements, RPP data stores, RPP components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the RPP discussed in this disclosure have been directed to real estate construction modeling, the innovations described in this disclosure may be readily applied to a wide variety of other fields and/or applications.

The following is claimed:

1. A processor-implemented electronic pipeline update message generating method, comprising:
obtaining, via a network, from a data feed, pipeline information regarding real estate construction jobs;
identifying, via a processor, a new real estate development and a building identification number for the new real estate development from the pipeline information, wherein the new real estate development is associated with a specified job type;
obtaining, via the network, additional information regarding the new real estate development by sending a query to a data source, wherein the query includes the building identification number;
determining, via the processor, based on information regarding the new real estate development, a geographic area and a unit type associated with the new real estate development;
analyzing, via the processor, user data to identify a user interested in pipeline information associated with the geographic area and the unit type; and
sending, via the network, an electronic message regarding the new real estate development to the user.
